(19) United States
(12) Patent Application Publication
(10) Pub. No.: US 2023/0161649 A1
(43) Pub. Date: May 25, 2023

(54) COMPUTER AIDED DESIGN SYSTEM, APPLICATION, AND APPLICATION PROGRAMMING INTERFACE

(71) Applicant: KittyCAD, Inc., San Francisco, CA (US)

(72) Inventors: Hannah Bollar, San Francisco, CA (US); Jordan Noone, Agoura Hills, CA (US); Jessica Frazelle, San Francisco, CA (US); Jenna Bryant, Agoura Hills, CA (US)

(21) Appl. No.: 17/991,793

(22) Filed: Nov. 21, 2022

Related U.S. Application Data
(60) Provisional application No. 63/281,572, filed on Nov. 19, 2021.

(51) Int. Cl. G06F 9/54; G06F 30/12

(52) U.S. Cl. CPC G06F 9/543; G06F 30/12

(57) ABSTRACT

Described herein are various systems, devices, methods, and servers including but not limited to a system implementing a computer aided design application and an associated computer aided design application programming interface and scripting language, a client device implementing a computer aided design application programming interface and scripting language both associated with a computer aided design application, a first method, operational at a client device, implementing a computer aided design application programming interface and scripting language both associated with a computer aided design application, a server implementing computer aided design application and an associated computer aided design application programming interface and scripting language, and a second method, operational at a server, implementing a computer aided design application and an associated computer aided design application programming interface and scripting language.

### CROSS-REFERENCE TO RELATED APPLICATIONS

This application for patent claims priority to and the benefit of provisional patent application No. 63/281,572 entitled “Computer Aided Design System, Application, and Application Programming Interface” filed in the United States Patent and Trademark Office on Nov. 19, 2021, the entire content of which is incorporated herein by reference as if fully set forth below in its entirety and for all applicable purposes.

### BACKGROUND

### Field

The present disclosure relates to the field of computer aided design systems. More specifically, the present disclosure relates to computer aided design systems, computer aided design applications, and associated programming interfaces and scripting languages.

### Background

Computer aided design (CAD) relies on the processors and memory circuits (both working memory and storage memory) of computers, sometimes called computer workstations. CAD permits users to create, analyze, modify, and optimize mechanical and electrical designs before physically implementing the designs. The designs may be based on compilations of modeled objects (e.g., goods and materials) comprised of one or more component parts, subassemblies, and assemblies. One or more mathematical formulae may mathematically represent each modeled object. The formulae account for myriads of variables that together define the modeled object. For example, a steel beam model may specify its shape (e.g., I-beam, T-beam), width, length, height, alloy type, hardness, tensile strength, elongation, fatigue strength, corrosion plasticity, melting point, etc. A model of an electrical capacitor may specify its shape (e.g., chip or with leads), width, length, height, form factor, capacitance, tolerance, temperature range, series resonance frequency, parasitic inductance, etc. Formulas used to model objects with precision may require tens of variables to achieve realistic results for analysis and optimization.

Additionally, while component objects may be created and analyzed individually, it may be necessary for CAD systems to combine the component objects to form subassemblies and assemblies to obtain the full benefit of using a CAD system. Therefore, CAD systems may have an ability to model the subassemblies, to account for interactions between component objects, and may have an ability to model assemblies, to account for interactions between subassemblies as well as interactions between modeled objects. There may be significant demands made on the processors and memory circuits of the computers that employ CAD.

### BRIEF SUMMARY OF SOME EXAMPLES

Examples described herein include various systems, devices, methods, and servers including but not limited to a system implementing a computer aided design application and an associated computer aided design application programming interface and scripting language, a client device implementing a computer aided design application programming interface and scripting language both associated with a computer aided design application, a first method, operational at a client device, implementing a computer aided design application programming interface and scripting language both associated with a computer aided design application, a server implementing computer aided design application and an associated computer aided design application programming interface and scripting language, and a second method, operational at a server, implementing a computer aided design application and an associated computer aided design application programming interface and scripting language.

### BRIEF DESCRIPTION OF THE DRAWINGS

FIG. 1 is a schematic representation of an environment in which computer aided design (CAD) systems may exist according to some aspects of the disclosure.

FIG. 2 is a flow diagram depicting an example of a workflow involving multiple entities employing multiple CAD applications according to some aspects of the disclosure.

FIG. 3 is a flow diagram depicting an example of a workflow involving a CAD application, CAD application programming interface (API), and scripted language according to some aspects of the disclosure.

FIG. 4 is a schematic representation of an environment in which a client device may utilize an application programming interface (API) to interface with a server hosting a CAD application according to some aspects of the disclosure.

FIG. 5 is a block diagram illustrating an example of a hardware implementation of a client device employing a processing system according to some aspects of the disclosure.

FIG. 6 is a flow diagram of a method operational at a client device according to some aspects of the disclosure.

FIG. 7 is a block diagram illustrating an example of a hardware implementation of a server employing a processing system according to some aspects of the disclosure.

FIG. 8 is a flow diagram of a method operational at a server according to some aspects of the disclosure.

### DETAILED DESCRIPTION

In the following description, specific details are given to provide a thorough understanding of the described implementations. However, it will be understood by one of ordinary skill in the art that the implementations may be practiced without these specific details. For example, circuits may be shown in block diagrams or in a simplified representation to avoid obscuring the implementations in unnecessary detail. In other instances, well-known circuits, structures, and techniques may be shown in detail so as to not to obscure the implementations.

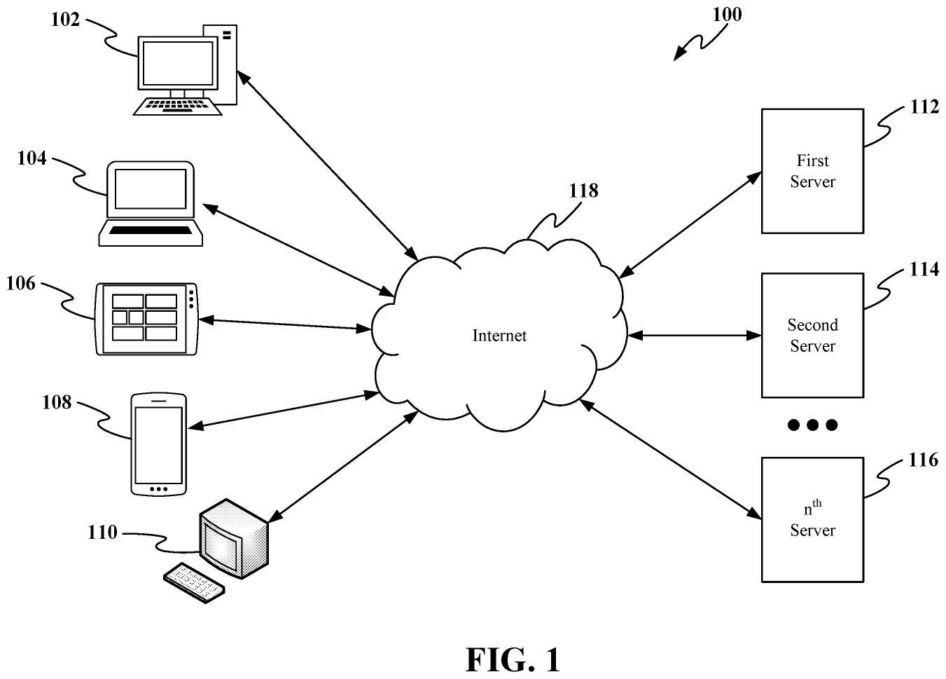

FIG. 1 is a schematic representation of an environment 100 in which computer aided design (CAD) systems may exist according to some aspects of the disclosure. A CAD system may be embodied in a device having a data input device, a data output device, working memory, storage memory, and a processor coupled to the data input device, the data output device, the working memory, and the storage memory. Examples of such devices include a personal computer 102, a laptop computer 104, and a tablet computer 106. The preceding list is exemplary and not limiting. Before utilizing a CAD system, the personal computer 102, laptop computer 104, and tablet computer 106 may need to download an entire application (e.g., a software suite comprised of many software modules, predefined object models, etc.). The download may be, for example, from a server such as any of the first server 112, second server 114, or n^{th} server 116 (where n is an integer greater than 2), via the Internet 119. Only after the entire application is downloaded and stored in a storage memory (not shown) of the personal computer 102, laptop computer 104, or tablet computer 106, can the processor (not shown) and associated working memory (not shown) execute and make use of the application. The personal computer 102, the laptop computer 104, and the tablet computer 106 may each have processors (not shown) that can perform large numbers of calculations promptly, sometimes simultaneously, along with sufficient working memory to support the execution of the calculations in real-time (e.g., an undue delay is less than desired). Processors of this type may use co-processors, multiple cores, or both, alongside sufficient quantities of working memory (e.g., random access memory) to handle the execution of the calculations in real-time.

Also depicted in FIG. 1 are other devices, including a smartphone 108 and a terminal 110 (e.g., a terminal per se or a computer with limited processing capability and memory storage capacity). The preceding list is exemplary and not limiting. These other devices may not have the processor power, the memory storage capacity, or both, as might be found in the personal computer 102, laptop computer 104, or tablet computer 106. Therefore, the smartphone 108, the terminal 110, or other devices with limited processing capability and/or memory storage capacity may be unlikely to be used as a component of a CAD system because it may be difficult to load and execute a CAD application on such devices.

As shown in FIG. 1, the personal computer 120, the laptop computer 104, the tablet computer 106, the smartphone 108, and the terminal 110 are all communicatively coupled to one or more of the first server 112 through the n^{th} server 116 via the Internet 118. The devices and servers may couple to the Internet 118 using any known type of communication network, such as wired or wireless communication networks known to those of ordinary skill in the art.

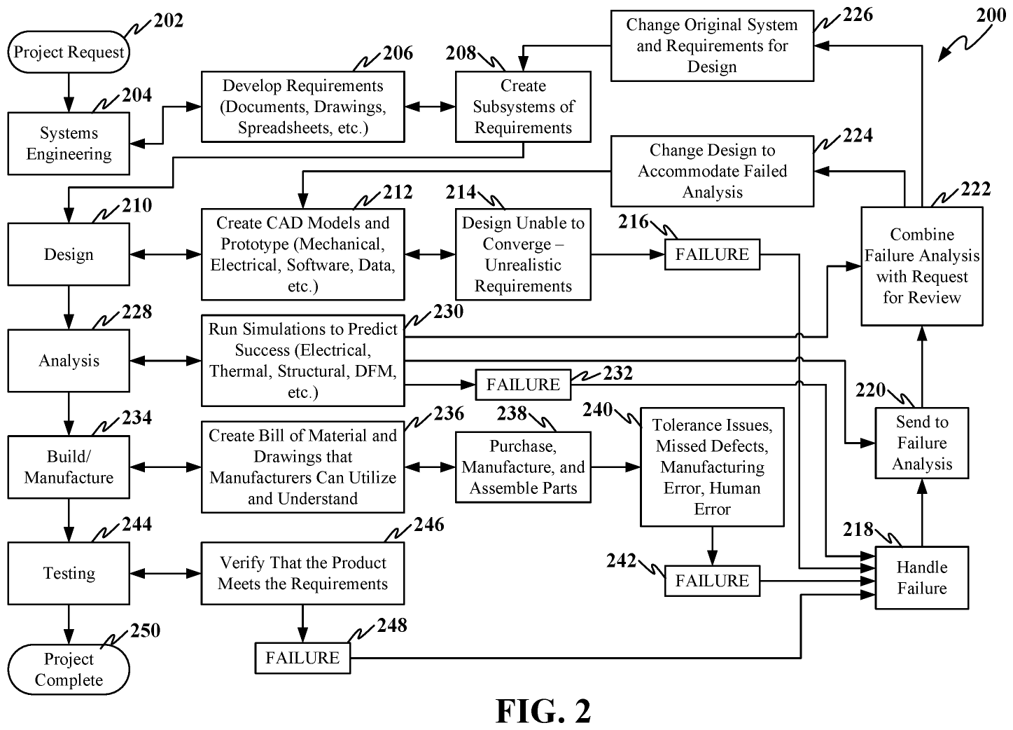

FIG. 2 is a flow diagram depicting an example of a first workflow 200 involving multiple entities employing multiple CAD applications (e.g., CAD applications for system engineering, design, analysis, manufacture, and test) according to some aspects of the disclosure. Any of the multiple CAD applications may be downloaded to any of the personal computer 102, the laptop computer 104, or the tablet computer 106, all of FIG. 1. The downloads may be from any of the first server 112 through the n^{th} server 116, all of FIG. 1. The multiple CAD applications may not be downloaded to the smartphone 108 or the terminal 110 of FIG. 1. Neither of those two devices possesses the processing power or memory needed by any one or more multiple CAD applications.

At 202, a project request is made to a systems engineering 204 entity. The systems engineering entity 204 may utilize a systems CAD application (not shown) to develop requirements 206 according to the parameters provided to the systems engineering 204 entity with the project request. The requirements 206 may be formalized in various documents, drawings, spreadsheets, etc., all generally prepared by the systems engineering entity 204. The systems engineering entity 204 may also create subsystems of requirements 208, which may be developed from the earlier mentioned requirements 206. The requirements 206 and subsystems of requirements 208 may be forwarded to a design entity 210.

The design entity 210 may create CAD models and prototype items 212 (e.g., mechanical, electrical, software, data, etc.) using a design CAD application (not shown). At 214, the design entity 210 may realize that one or more of its designed CAD models and prototype items 212 may be unable to converge (for example, due to unrealistic requirements). Accordingly, the design entity 210 may declare a failure 216. Declaring the failure 216 may energize a bureaucracy to handle the failure at block 218. Once the failure is handled, the workflow 200 may be sent to block 220 for failure analysis. Once the failure analysis is completed, at block 222, the failure analysis may be combined with a request for a review.

Based on the results of the review at block 222, an order may be given to the design entity 210 to change the design according to accommodate the failed analysis at block 224. Alternatively, or additionally, based on the results of the review at block 222, an order may be given to the systems engineering entity 204 to change the original system and requirements for the design at block 226. If the order is given to the systems engineering entity 204, the workflow 200 may return to creating subsystems of requirements 208. After that, the systems engineering entity 204 may provide new requirements 208 to the design entity 210. If the order was given to the design entity 210 to change the design to accommodate the failed analysis at block 224, the design entity 210 may again create CAD models and prototype items 212. The workflow 200 may loop again as many times as are needed to overcome the failure 216.

Once the designs converge 214, the design entity 210 may forward the designs to the analysis entity 228. The analysis entity 228 may utilize an analysis CAD application (not shown) and, at block 230, may run simulations to predict success (e.g., any one or more of electrical, thermal, structural, design for maintainability (DFM), etc. simulations). The simulations run at block 230 may result in a failure 232, which may again energize the bureaucracy at block 218 to handle the failure. Alternatively, the simulations run at block 230 may be simulations used for failure analysis at block 220, simulations combined with failure analysis, and the request for review at block 222, or both. In all three circumstances, the workflow 200 would return to block 224, block 226, or both and cycle through all of the preceding workflow 200 processes as many times as are needed to overcome any failures (e.g., failure 216, failure 232).

Once the analysis is completed, the analysis entity 228 may forward the designs to the build/manufacture entity 234. The build/manufacture entity 234 may utilize build/manufacture CAD application (not shown) and, at block 236, may create a bill of material and drawings that manufacturers can utilize and understand. After that, at block 238, materials may be purchased for the manufacture and assembly of parts. However, at block 240, tolerance issues, previously missed defects, manufacturing error, human error, or any combination thereof may conspire to cause another failure 242. In such a circumstance, the workflow 200 would return to block 218 and, starting at block 218, cycle through all of the preceding workflow 200 processes as many times as are needed to overcome any failures (e.g., failure 216, failure 232, failure 242).

Once the build/manufacture entity 234 has completed its tasks successfully, the build/manufacture entity 234 may pass responsibility for the project to the testing entity 244. The testing entity 244 may utilize a testing CAD application (not shown) and, at block 246, may test the product to verify that the product meets the original or revised requirements (as the case may be). However, at block 246, testing may reveal that the product does not meet the requirements, and still another failure 248 might be declared. In such a circumstance, the workflow 200 would return to block 218 and, starting at block 218, cycle through all of the preceding workflow 200 processes as many times as are needed to overcome any failures (e.g., failure 216, failure 232, failure 242, failure 248), until, finally, at block 250, the project could be successfully completed and the product could be built.

The processes described above in connection with the workflow 200 of FIG. 2 may not be all of the processes involved in initially specifying a product and finally building the product. Other processes may be added, and described processes may be performed in sequences not illustrated in FIG. 2. However, to the extent that the workflow 200 accurately describes present workflow processes utilizing a plurality of CAD applications by a plurality of entities, it should be clear to the ordinary person of skill in the art that the workflow 200 is complicated and repetitious.

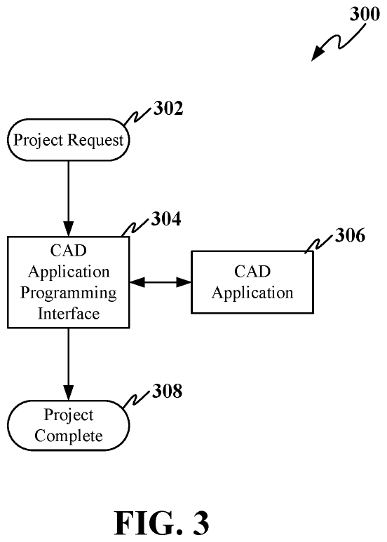

FIG. 3 is a flow diagram depicting an example of a workflow 300 involving a CAD application 306, CAD application programming interface (API) 304 (also referred to as an API for CAD), and scripted language (not shown) according to some aspects of the disclosure. At block 302, a project request may be made to a given entity (not shown). The given entity may utilize a CAD API 304 to input data to and receive data from a CAD application 306. The CAD application 306 may be used to satisfy system engineering requirements, design requirements, analysis requirements, build/manufacture requirements, and testing requirements. The given entity (i.e., one entity), or a plurality of entities working in parallel (not shown), may use the CAD API 304 to perform all tasks in a life cycle (i.e., from initial request to final completion) of a product. Once the life cycle of the product is complete, at block 308, the project is complete. The CAD API 304 may reside in a smartphone or terminal, such as the smartphone 108 or terminal 110 of FIG. 1. The CAD application 306 may reside in any of the first server 112 through the n^{th} server 116 (individually or collectively referred to herein as the “server”). Because the CAD application 306 resides in the server, devices with limited processing power, memory storage capacity, or both may employ the CAD API 304 (which utilizes little processing power and memory storage capacity in comparison to the server) and obtain the benefit of the processor power and memory storage capacity of the server.

With reference to a new scripting language for use with the CAD application and/or CAD API, in some examples, the scripts generated using the scripting language described herein may not be accessed in an automated manner. For example, and without limitation, according to one aspect, they cannot be called by other scripts, called in a command line, deployed to the cloud, and run (executed) there (e.g., run in remote servers, etc.).

The CAD application and associated CAD API described herein may utilize a file type that may be a new file type for CAD. As used herein, the term “file type” may be used to refer to the functional and/or operational structure of a file (e.g., how the file is built/constructed/used) and should not be confused with the term “file extension” which relates to how the file is named. Files that store data using the file type for CAD may utilize digital certificates and may include an edit history. Files that store data using the file type for CAD may include a capability that permits the file to be generated with a last allowable access date that may be a date on which access to the file automatically expires or the date on which access to the file may be revoked.

In some examples, files that store data using the file type for CAD may be stored as a non-fungible token (NFT) on a blockchain.

In some examples, files that store data using the file type for CAD may include smart contracts on blockchain (e.g., licensing, resale agreements, profit-sharing, etc.). As used herein, smart contracts on blockchain are programs stored on a blockchain that runs when one or more predetermined conditions are met. A smart contract may be used to automate the execution of an agreement so that all participants can be immediately sure of the outcome without any intermediary's involvement or time loss. Smart contracts may also be used to automate a workflow, triggering a following action when predefined conditions are met.

In some examples, files that store data using the file type for CAD may be accessed programmatically as an object. As used herein, an “object” may be a variable, a data structure, a function, or a method, and as such, it can be represented in a memory and referenced with an identifier. For example, one interaction (e.g., an object call) with a file of the described file type may be: partFile.mass( ) where partFile is the file name and mass is a function call on the file named partFile. Another example may be an interaction using the form partFile.mass, where partFile is the file name and mass is a property of the file named partFile. The files themselves, as objects, may be found within a given project according to a predetermined “foldering” structure. The predetermined foldering structure may be configured so that no file searching would need to be resolved and no name-overlapping would need to be resolved. As shown in the preceding two examples, the file being called as an object could be implemented in various manners. The preceding examples are provided for discussion and are non-limiting.

In some examples, the file type itself may define whether and which user/entity may view/interact with a file and/or whether and which a machine may access/print/manufacture a file. For example, files that store data using the file type for CAD may programmatically define which user/entity or machine may access a given file. For example, the file type may implicitly indicate that a first brand of a 3D printer may print the file, and a second brand of a 3D printer may not print the file. Or, as another example, the file type may implicitly indicate that a given machine shop (a first entity) may open a file, while a second machine shop (a different entity, a second entity) may not open a file.

In some examples, files that store data using the file type for CAD may allow programmatic access to CAD features (coordinate systems, sketches, solids, surfaces, edges, etc.). According to some examples, files that store data using the file type for CAD may allow programmatic access to CAD features in any programming language and on any operating system.

In general, the CAD application and associated CAD API described herein may allow code creation through user interaction in a graphic user interface (GUI). Conversely, the CAD application and associated CAD API described herein may allow code creation through GUI interaction with a user. In other words, the GUI may make suggestions to the user of ways to alter a model to obtain a desired result. For example, direct interaction examples may include filling in a given component of something. The filling in may be toggled in the script as a user interface (UI) interaction or a typing interaction or in the GUI as a direct point and click interaction. By way of example, say a user is trying to place an item such as a vertex or cube or line in a 3D coordinate axis system (x,y,z), or in a 2D coordinate axis system (x,y). Instead of manually typing (entering) those values, the user might move to the location and identify it with a point-and-click; thereafter, the CAD application may automatically update the values in the code. The opposite may also be true. For example, the user may type in the values, and those values may be automatically updated in the graphics representation of the values. Furthermore, the user may be able to choose how the user and the CAD application interact, for example, coding to create what the user wants, using point-and-click and have the code be automatically generated by the user's interaction with a GUI, or coding and using point-and-click, as well as choosing whether to have sections automatically generate aspects or manually generate aspects as the user sees fit.

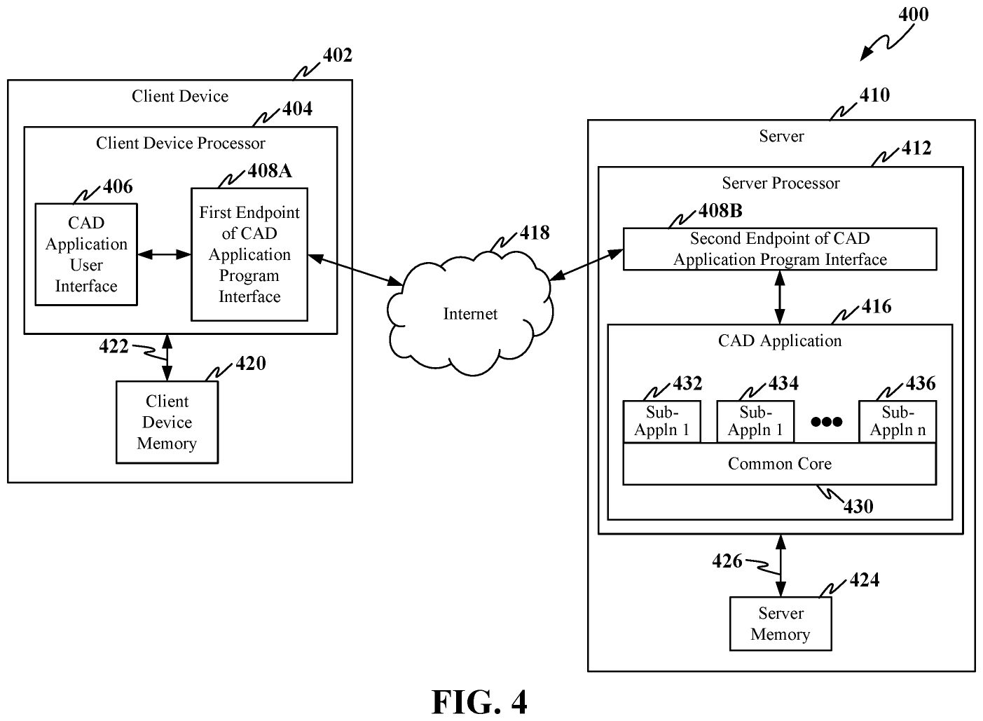

FIG. 4 is a schematic representation of an environment 400 in which a client device processor 404 of a client device 402 (e.g., a terminal) may utilize a CAD application user interface 406 and first endpoint of a CAD application programming interface (CAD API 408A) (on the client device side) to interface with a CAD application 416 hosted on a server 410 via a second endpoint of the CAD API 408B (on the server side). The user interface may be a graphical user interface or another user interface (that may not include a graphical aspect and may be, for example, text based and/or voice based). The client device 402 (and first endpoint of the CAD API 408A) and server 410 (and second endpoint of the CAD API 408B) may be communicatively coupled via the Internet 118 using any known type of communication network, such as wired or wireless communication networks known to those of ordinary skill in the art. Intermediate nodes forming the communication path between the CAD API 408A and the CAD API 408B are omitted to avoid cluttering the drawing. The client device 402 may be, for example, the personal computer 102, the laptop computer 104, the tablet computer 106, the smartphone 108, or the terminal 110, or any similar device, as shown and described with reference to FIG. 1. The server 410 may be, for example, any of the first server 112 through the n^{th} server 116 as shown and described in connection with FIG. 1. The client device 402 may include a client device memory 420, which may be coupled to the client device processor 404 via a communication bus 422. The server 410 may include a server memory 424, which may be coupled to the server processor 412 via a communication bus 426. In some examples, no aspects of the CAD application 416 need to be loaded to the client device memory 420, making use of the first endpoint of the CAD API 408A and access to the CAD application 416 via the second endpoint of the CAD API 408B available for client devices that do not have advanced processors (e.g., have minimal processing power such as might be found in a smartphone or “dumb” terminal) and/or lack quantities of memory that would be sufficient to store the CAD application software/code. Indeed, the CAD API (comprised of the first endpoint of the CAD API 408A and the second endpoint of the CAD API 408B and collectively referred to as the CAD API 408) described herein and illustrated in FIG. 4 may not need to rely on any software/code being installed locally to the client device 402. For example, and in contrast, other APIs for CAD may need a parent program to be installed locally to the client device 402.

The CAD application 416 and associated CAD API (e.g., first endpoint of CAD API 408A, second endpoint of CAD API 408B, collectively referred to hereinafter as “CAD API 408”) described herein may be designed so that more complex software need not be built on top of it. More specifically, at least a portion of the CAD application 416 described herein may be configured as a common core 430, below a plurality of sub-applications (e.g., a first sub-application 432, a second sub-application 434, . . . , an nth sub-application 436, where n is a positive integer) (collectively referred to as the CAD application 416). The plurality of sub-applications may relate to respective features of the CAD application 416, such as, but not limited to, design, modeling, analysis, optimization, testing, documentation, and manufacturing, etc. Due to the comprehensive nature of the CAD application 416, there may be no need to build external programs on the CAD application 416.

In one sense, the common core 430 may form a foundation on which rests the plurality of sub-applications that may implement the various features of the CAD application 416. The plurality of sub-applications may interact with and/or utilize native functions of the common core 430. The plurality of sub-applications may interact with each other directly or indirectly (e.g., via the common core 430) without having to call external applications (e.g., that may not interface with the common core 430). In its foundational sense, the common core 430 may be referred to as a kernel or as an engine. However, the common core 430 of the CAD application 416 may be distinct from an operating system kernel, which, as known to those of skill in the art, is a computer program at the core of a computer's operating system. The operating system kernel may have ultimate privileges, and it may be the first thing that boots when a computer processing system is turned on. In contrast, the common core 430 (kernel or engine) of the CAD application 416 described herein may lie above the operating system kernel (not shown). There may not be any intermediate programs between the operating system kernel and the common core 430 of the CAD application 416.

In its foundational position, the common core 430 of the CAD application 416 may, for example and without limitation, perform server side operations that may include basic mathematic operations (e.g., addition, subtraction, multiplication, division), to higher level operations (e.g., solutions to algebraic, geometric, and trigonometric functions), to even higher level operations (e.g., calculus, partial differential equations, differential equations, Fourier transforms and inverse transforms, Laplace transforms and inverse transforms, thermodynamics, static and dynamic mechanical, structural, materials science, environmental, and electrical engineering functions), and logic operations (e.g., Boolean logic) that may facilitate the operation of the sub-applications of the CAD application 416. Furthermore, and for exemplary and non-limiting purposes, the common core 430 of the CAD application may perform services related to rendering and handling of graphic processing unit (GPU) multi-threading, etc. Because the common core 430 of the CAD application 416 may perform the operations and functions for all of the various features and sub-applications of the CAD application 416, the CAD application 416 may not need to call on external programs that are not interfaced with the common core in order to implement the various features offered by the CAD application 416. Use of the common core 430 may therefore reduce redundancy by, for example, facilitating the use of a shared common resource (i.e., the common core 430). Accordingly, communications, speed, and energy (e.g., electrical power) burdens placed on processors implementing known CAD systems (that may rely on a plurality of applications (e.g., external applications) that do not share a common core) may be alleviated by the use of the CAD application 416 described herein.

Additionally, the CAD application 416 and associated CAD API 408 may be designed for future improvements to its logic and intelligence, which may be added to the CAD application 416 and/or CAD API 408 as time goes on. Because each sub-application may utilize the common core 430, some of the future improvements may only need to be pushed to, or made to, the common core 430. This may reduce redundancy and increase precision because one change to the common core may be used to implement the future improvements to the CAD application 416 as a whole (instead of implementing the future improvements by pushing changes to each of the plurality of sub-applications). Of course, nothing herein is intended to limit the implementation of any future change to the CAD application 416 or CAD API 408 to a change to the common core 430 alone.

The CAD application 416 may operate on objects as well as subassemblies and assemblies comprised of those objects. The objects may range from basic building blocks of two-dimensional and three-dimensional shapes to shapes that are themselves made of multiple intricate or detailed shapes (e.g., complex shapes). In addition to shape, each object may include parametric data that, for example, quantify the qualities of the object and how the object reacts to forces and the environment (e.g., each object may be associated with a host of parametric data quantifying aspects of the object for purposes of, at least, design, modeling, analysis, optimization, testing, documentation, and manufacturing).

According to some aspects, the CAD API 408 described herein may be described as an API-first developmental item. In one example, the CAD API 408 need not be built on top of a graphical user interface program. It may be designed to interface with other applications, including but not limited to: word processing, spreadsheet, circuit simulation, thermal analysis, continuous integration, engineering analysis, computer aided manufacturing, physical inspection software, robot path planning, enterprise resource planning, manufacturing resource planning, product lifecycle management, and/or supply chain optimization. Furthermore, other applications may wrap the CAD API described herein into other use cases, such as, but not limited to, program management, financial planning, billing, procurement, and/or systems engineering, etc.

In some examples, the CAD API 408 may be built as a representational state transfer (REST) API (also referred to as a RESTful API). When built as a REST API, the CAD API 408 allows any programming language (e.g., but not limited to, Python, JavaScript, Bash, Rust, Ruby, Golang, C, C++, COBOL), any operating system (e.g., but not limited to, MacOS, iOS, Windows, Windows Phone, Windows Embedded, Microsoft Phone, Linux Distributions), etc. to call its commands. Commands may include, but are not limited to, DELETE, PUT, GET, POST, PATCH, and/or CUSTOM Parameters. A REST API provides access to data by using a uniform and predefined set of operations. REST APIs may be based on uniform resource language (URLs) and the hypertext transfer protocol (HTTP). REST is not a protocol or standard. Instead, REST defines a set of six architectural constraints that are summarized as follows:
1. Client-server architecture—made of clients, servers, and resources, with requests managed through HTTP.
2. Uniform interface—defines the interface between client and server so that information may be transferred in a standard form.
3. Stateless client-server communication—meaning that each request from a client to a server is independent. Additionally, no client information is stored between GET requests, and each request is separate and not connected to another request.
4. Cacheable—maintains cached responses between client and server, avoiding any additional processing
5. Layered system—layers are arranged hierarchically. The system organizes each type of server (e.g., those responsible for load balancing, those responsible for security, etc.) involved and is invisible to the client.
6. Code-on-demand—the ability to send executable code from the server to the client upon request. This may allow client functionality to be extended by downloading code to the client and executing the downloaded code in the form of applets and scripts.

A REST API may be different from, for example, a simple object access protocol (SOAP) API. A SOAP API uses extensible markup language (XML) to transfer data. SOAP APIs require advanced security and more bandwidth than a REST API. SOAP APIs cannot cache. A REST API may also be different from an extensible markup language-remote procedure calls (XML-RPC) API. An XML-RPC API utilizes a specific XML format to transfer data. A client performs an RPC by sending an HTTP request to a server that implements XML-RPC. The server returns an HTTP response. A REST API may also be different from a JavaScript object notation (JSON)-RPC API. A JSON-RPC API works the same way as an XML-RPC API but uses JSON instead of XML format.

According to some aspects, the CAD API 408 may handle multi-threading instead of having a user handle multi-threading. Similarly, the CAD API 408 may handle GPU implementations and/or accelerations instead of a user. Still further, the CAD API 408 may handle GPU and/or CPU based multi-threading instead of a user.

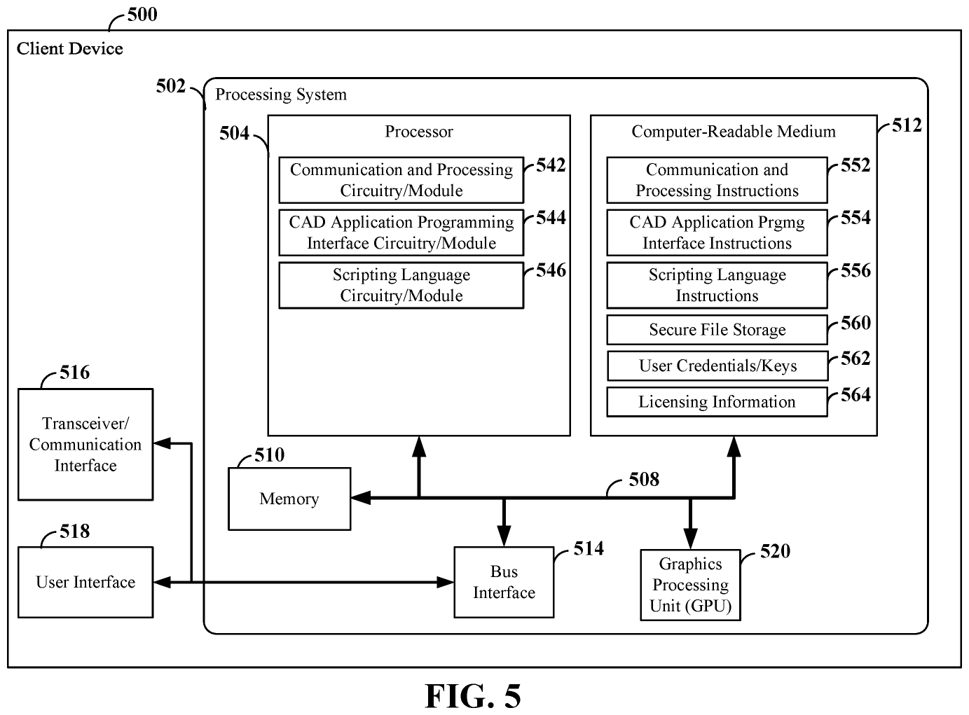

FIG. 5 is a block diagram illustrating an example of a hardware implementation of a client device 500 employing a processing system 502 according to some aspects of the disclosure. For example, the client device 500 may correspond to a personal computer, a laptop computer, a tablet computer, a smartphone, a terminal, or a similar device. Examples of the client device include the personal computer 102, the laptop computer 104, the tablet computer 106, the smartphone 108, and the terminal 110, all as shown and described above with reference to FIG. 1.

The client device 500 may be implemented with the processing system 502 that includes one or more processors 504. Examples of processors 504 include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. In various examples, the client device 500 may be configured to perform one or more of the functions described herein. That is, the processor 504, as utilized in the client device 500, may be used to implement any one or more of the processes and procedures described herein.

In this example, the processing system 502 may be implemented with a bus architecture, generally represented by bus 508. Bus 508 may include any number of interconnecting buses and bridges depending on the specific application of the processing system 502 and the overall design constraints. The bus 508 links together various circuits, including one or more processors (represented generally by the processor 504), a memory 510, and computer-readable media (represented generally by the computer-readable medium 512). The bus 508 may also link various other circuits such as timing sources, peripherals, voltage regulators, and power management circuits, which are well known in the art and not described further.

A bus interface 514 may provide an interface between bus 508 and a transceiver/communication interface 516, which may provide a means for communicating with various other apparatus over a transmission medium (e.g., WAN/LAN, wired, and/or wireless interface).

A graphics processing unit (GPU) 520 may be provided. The GPU 520 may be coupled to the processor 504 via the bus 508. The GPU 520 may be a processor designed to accelerate graphics rendering and/or perform or accelerate the performance of other functions. The GPU may include memory (not shown). The GPU 520 may be optional.

A user interface 518 may be provided. The user interface 518 may provide a way for a user to input data to and obtain data from the client device 500. The data may be text, video, audio, or any combination thereof. The user interface 518 may include, for example, a keypad, a display, a touch screen, a speaker, a microphone, one or more switches, one or more control knobs, or any combination thereof. The preceding lists are exemplary and not limiting.

The processor 504 may be responsible for managing the bus 508 and general processing, including executing software stored on the computer-readable medium 512. When executed by the processor 504, the software may cause the processing system 502 (including the processor 504) to perform the various functions described herein for any particular apparatus. The computer-readable medium 512 and the memory 510 may also be used to store data manipulated by the processor 504 when executing software. For example, the memory 510 may store variable values, one or more final, and/or one or more intermediate solutions, as well as equations, to be executed commands, and data that is, in general, utilized by the processing system 502 (including the processor 504) to perform the various functions described herein for any particular apparatus.

One or more processors 504 in the processing system 502 may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium 512.

The computer-readable medium 512 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium 512 may reside in the processing system 502, external to the processing system 502, or distributed across multiple entities, including the processing system 502. The computer-readable medium 512 may be embodied in a computer program product. By way of example, a computer program product may include a computer-readable medium in packaging materials. In some examples, the computer-readable medium 512 may be part of the memory 510. Those skilled in the art will recognize how best to implement the described functionality presented throughout this disclosure depending on the application and the overall design constraints imposed on the system.

In some aspects of the disclosure, the processor 504 may include circuitry configured for various functions. For example, the processor 504 may include communication and processing circuitry/module 542, configured to communicate with one or more other client devices and/or one or more servers, such as, for example, the first server 112 through the n^{th} server 116 as shown and described with reference to FIG. 1. Communication may be accomplished via the transceiver/communication interface 516. In one example, the communication and processing circuitry/module 542 may be configured to communicate with one or more servers (such as the first server 112 through the nₜₕ server 116 of FIG. 1) via an application processing interface, such as the CAD API 408 as shown and described with reference to FIG. 4. In some examples, the communication and processing circuitry/module 542 may include one or more hardware components that provide the physical structure that performs processes related to computer aided design.

In some implementations where the communication involves receiving information, the communication and processing circuitry/module 542 may obtain information from a component of the client device 500 (e.g., from the transceiver/communication interface 516 that receives the information via a wired or wireless type of signaling suitable for the applicable communication medium), process (e.g., decode) the information, and output the processed information. For example, the communication and processing circuitry/module 542 may output the information to another component of the processor 504, to the memory 510, the computer-readable medium 512, the user interface 518, and/or to the bus interface 514. In some examples, the communication and processing circuitry/module 542 may receive one or more of signals, messages, other information, or any combination thereof. In some examples, the communication and processing circuitry/module 542 may receive information via one or more channels. In some examples, the communication and processing circuitry/module 542 may include functionality for a means for receiving. In some examples, the communication and processing circuitry/module 542 may include functionality for a means for processing, including a means for demodulating, a means for decoding, etc.

In some implementations where the communication involves sending (e.g., transmitting) information, the communication and processing circuitry/module 542 may obtain information from another component of the processor 504, from the memory 510, from the computer-readable medium 512, from the user interface 518, and/or from the bus interface 514. In some examples, the communication and processing circuitry/module 542 may process (e.g., derive, modulate, encode, etc.) the obtained information and output the processed information. For example, the communication and processing circuitry/module 542 may output the information to the transceiver/communication interface 516 (e.g., transmitting the information via a wired connection, radio frequency signaling, or some other type of signaling suitable for the applicable communication medium). In some examples, the communication and processing circuitry/module 542 may send one or more signals, messages, other information, or any combination thereof. In some examples, the communication and processing circuitry/module 542 may send information via one or more channels. In some examples, the communication and processing circuitry/module 542 may include functionality for a means for sending (e.g., a means for transmitting). In some examples, the communication and processing circuitry/module 542 may include functionality for a means for generating, including a means for modulating, a means for encoding, etc.

The processor 504 may further include a computer aided design application programming interface (CAD API) circuitry/module 544, configured, for example, as an interface between the user interface 518 and a CAD application (such as the CAD application 416 as shown and described in connection with FIG. 4) hosted on a server (such as, for example, the first server 112 through the n^{th} server 116 as shown and described with reference to FIG. 1 or the server 410 as shown and described with reference to FIG. 4).

The CAD API circuitry/module 544 of FIG. 5 and/or the CAD API 408 of FIG. 4, interchangeably referred to herein as the CAD API circuitry/module 544, may be configured to be accessed through a license. Licensing may enable the monetization of the CAD API circuitry/module 544. The computer-readable medium 512 may store licensing information 564. The licensing information 564 may be used by the processor 504 to determine which features, from among a plurality of licensable features offered via the CAD API circuitry/module 544, a given user is entitled to use. The user may be identified by user credentials/keys 562 stored on the computer-readable medium 512. According to some aspects, the CAD API circuitry/module 544 may be accessed through a license. It may be accessed via the Internet, and may be used without a need to download and/or locally run its associated CAD application. In some examples, the CAD API circuitry/module 544 may not need a graphical user interface (e.g., another type of user interface, such as a text user interface (TUI), is within the scope of the disclosure). According to some aspects, the CAD API circuitry/module 544 may have, for example, individual engines/portions/sub-applications monetized separately from other engines/portions/sub-applications. For example, a physics engine (e.g., physics portion, physics sub-application) may be monetized separately from a rendering engine (e.g., rendering portion, rendering sub-application) and/or from other aspects of the overall CAD application (e.g., file output requirement and a data input requirements). Still further, according to some aspects, the CAD API circuitry/module 544 may be monetized per API call. For example, monetization may be per a computer resource (e.g., memory, CPU, GPU, threads, network, time, etc.) used by an API call.

According to some aspects, the CAD API circuitry/module 544 may call a local computation that may be handled by the processor 504 (or client device processor 404 as shown and described with reference to FIG. 4). In such aspects, preceding the call, the client device 500 may be queried to determine if the processor 504 (or client device processor 404) and associated memory 510 (or client device memory 420) are sufficient to perform the local computation.

According to some aspects, the server binary (e.g., the CAD application 416 resident on the server 410) may be run locally (at the server 410). According to this aspect, a user may access the server binary over a local network access, such as, for example, “localhost.” Alternatively, the server binary may be operated remotely (e.g., CAD API circuitry/module 544 may call a remote computation) by accessing the CAD application via the CAD API anywhere the server binary is hosted. The call for the remote computation may be made to the server 410. Examples of the server 410 include but are not limited to the first server 112 through n^{th} server 116 as shown and described with reference to FIG. 1, and/or the server 410 (or more specifically to the server processor 412) as shown and described with reference to FIG. 4.

In some examples, the CAD API circuitry/module 544 may provide a programmatic way to link a physical or a digital design to software elements, intelligence, automation, etc. For example, an object associated with a file may provide digital manufacturing instructions, or supply chain specifications, or other data relevant to other software elements, intelligence, automation, etc.

In some examples, the CAD API circuitry/module 544 may enable a remote CAD application, such as, for example, CAD application 416 on the server 410 as shown and described with reference to FIG. 4, to use voxels as an interactive element. Using voxels as an interactive element, the CAD application 416 may render an object with unlimited detail. For example, using voxels as an interactive element may allow for infinite scroll-in and infinite scroll-out. This aspect may allow complex objects, like Fibonacci objects, to be created. In addition to or instead of using voxels, the CAD application 416 may use constructive solid geometry simulation (CSGS), signed distance functions (SDF), material point method (MPM) and/or other algorithm techniques to allow for solid multi-materials in the design itself. These uses may improve applications related to 3D printing and non-rigid project constructions, for example.

Using the CAD API circuitry/module 544, a user may save a “script creation” and/or a “script created” version of a file as a secure file. Alternatively, the user may save the “script creation” and/or the “script created” version of the file as a non-secure file. The “script creation” version of the file may include the human readable script used to create the “script created” version of the file. The “script creation” version of the file may therefore be understood as a human-readable data file. The script may, for example, include human readable commands/instructions related to the design/generation of a given object having a given geometry. The “script created” version of the file may be created by the “script creation” file. The “script created” version of the file may include information (e.g., machine readable code) that describes the given geometry of the given object in a way that can be utilized, rendered, manipulated, analyzed, and/or optimized, etc. by a processing system (e.g., a processing system including a processor and computer-readable memory). The information of the “script created” version of the file (e.g., the information/machine code that describes the given object) may be referred to as the “actual object information.” The “script created” version of the file may therefore be understood as a non-human readable data file. In some examples, the “script creation” and/or “script created” file may be stored in a general location (not shown) in the computer-readable medium 512 as a secure or a non-secure file. In some examples, the “script creation” and/or “script created” file and may be stored in a secure file storage 560 location (e.g., an access restricted/encrypted location) in the computer-readable medium 512 as a secure or a non-secure file. Examples of a secured file include, but are not limited to, a signed file and a non-fungible token.

Using the CAD API circuitry/module 544, a user may cause a CAD application, such as the CAD application 416 as shown and described with reference to FIG. 4, to execute project merges, which may be similar to code merges in the computer coding arts. Project merges may be performed to merge multiple testing, simulation, and scaling projects from a mechanical engineering or project design perspective. For example, in a code merge, a user may edit a project and add a new feature. If the project owner approves the new feature, the project owner may merge the new code (expressing the new feature) into the project. A user may use the CAD API circuitry/module 544 to request a CAD application, such as the CAD application 416 as shown and described with reference to FIG. 4, to automatically run a “confirm this doesn't break the entire system of constraints you defined” feature. This feature may be integrated into a merge system used to merge projects. By way of example, a user may add a feature to a project, but the added feature may cause the project to fail its thermal requirements (e.g., the added feature broke the thermal specifications). An example of such a feature may be one in which the user inadvertently blocked the airflow for a set of fans by changing a mold injected plastic covering from one with certain holes to one without those certain holes. The user may push up the changes to the project. The CAD application, or a component or sub-application thereof, may run thermal simulations automatically (e.g., without any need for the user to initiate the running of the thermal simulations). Because the user broke the thermal specifications, the CAD application may alert the user and, for example, highlight the error, describe the error, or otherwise make the user aware of the error and not merge the user's changes until the user fixes the problem with the airflow.

In some examples, the CAD API circuitry/module 544 may include one or more hardware components that provide the physical structure that performs processes related to computer-aided design. The CAD API circuitry/module 544 may further be configured to execute CAD API instructions (software) 554 stored in the computer-readable medium 512 to implement one or more of the features, functions, aspects, and/or methods described herein that may be related to using the CAD API as described herein.

The processor 504 may further include scripting language circuitry/module 546, configured to provide and utilize a scripting language created to interact with a CAD application, such as CAD application 416, as shown and described with reference to FIG. 4. The scripting language may be referred to as a scripting language for CAD herein. According to some aspects, the scripting language may include scripting language for geometric operations and other operations.

For example, in addition to geometric operations, also included in the scripting language described herein may be the facility for computer aided manufacturing (CAM) focused operations. In general, while providing for programmable geometry, the CAD application and associated CAD API described herein may also enable the ‘programmability’ of any aspect of CAD and/or CAM, including but not limited to the steps from the formulation of an idea for a project and a product thereof, through specification, analysis, test, planning of a manufacturing process, and manufacturing of the physical product using the manufacturing process. The accomplishment of all steps may be facilitated by a unified and coordinated “behind the scenes” approach (as described herein) to handling all these steps. A system, including a CAD application and associated CAD API and scripting language (as described herein), which handles these steps in a unified, coordinated, behind the scenes, and seamless manner is not known to exist. Instead, the aspects including but not limited to system engineering, design, analysis, build/manufacturing, up thorough and including final product testing are not seamlessly handled behind the scenes via the use of a single CAD application and associated CAD API and scripting language. Instead, they are more or less patched in on a one-off basis and require a great deal of separate human team interactions during and between the steps. According to some aspects, the scripting language described herein may or may not include a visual/rendering element.

The scripting language circuitry/module 546 may be used to execute a scripting language that may implement any one or more of the following exemplary features and may be used to achieve the handling of the above-described steps (as well as other CAD/CAM related steps) in a unified, coordinated, behind the scenes, and seamless manner. In other systems, as illustrated using the workflow of FIG. 2, an individual may be thought of as saying: “I want this design, but the analysis does not work. Therefore, I will manually have to use native features, like spreadsheets, and return to originally stated system requirements to modify those requirements to achieve a manufacturable product.” In contrast, a user of the CAD application and associated CAD API and scripting language described herein may enter a command, such as, for example, “AdjustDesignByAnalysis” and the CAD API described herein may begin to provide recommendations and/or automatically reconfigure the original design. Additionally, for example, if the system engineering requirements change from the customer standpoint, instead of putting in the human hours to discuss the changes amongst a plurality of teams and manually re-running various steps of the design and analysis process, an overarching pipeline configured upon the CAD application and associated CAD API and scripting language might be caused to update itself because of the customer's changed system engineering requirements.

By way of an analogy, the CAD application and associated CAD API and scripting language described herein may define a cube. All designs may make use of the defined cube. In other words, all systems refer to the defined cube. Utilizing the CAD application and associated CAD API and scripting language described herein, a user can update the parameters associated with the cube (e.g., change a bolt pattern and/or a bracket), and once updated, every system utilizing the defined cube may be updated automatically in a unified, coordinated, behind the scenes, and seamless manner. In contrast, with known ‘scriptable’ CAD, the one cube may exist in several systems. Still, a change to the cube means that a user must manually update the changed cube in each system employing the cube, pay attention to anything and everything that makes use of any portion of the cube (e.g., square projections of the cube, sketches incorporating the cube, edges where one or more edges includes the cube, surfaces where one or more surfaces include the cube, solids that include/incorporate the cube, complex objects of a multitude of features that include any feature of the cube, brackets that attach to the cube, etc.) making sure that all systems are updated as necessary, or manually call the update herself. In short, the CAD application and associated CAD API and scripting language described herein may enable the black-boxing of an entire project process, not just the design (geometric scripting) process. The CAD application and associated CAD API and scripting language described herein may be thought of as being used to convert a known manual hardware process into a continuous integration (CI)/continuous deployment (CD) (or continuous delivery (CD)) code pipeline. As used herein, CI may refer to the automation of the building and testing of an application on every new commit (i.e., save of an updated version). As used herein, continuous deployment (CD) may refer to the automation of the building, testing, and deploying of an application, where if all tests pass, every new commit may push new code (or any new hardware changes, changes in general, etc.) through an entire development pipeline to production with no manual intervention. Accordingly, in a first sense, continuous integration/continuous deployment (CI/CD) may be understood as the automatic manufacturing of a new design once it passes through the CI/CD processes, without human intervention. In a second sense, however, CI/CD may be understood as continuous integration/continuous delivery (CI/CD), where continuous delivery may refer to a state where the application is always ready to be deployed. According to this second sense, continuous integration/continuous delivery (CI/CD) may employ a manual step to actually deploy the application (or code, hardware changes, changes in general, etc.).

In some examples, the scripting language for CAD may allow for version control. As used herein, version control may be different from that used in Git, Subversion (SVN), Mercurial, Hg, Microsoft Teams Server, or Perforce, for example. The preceding list is exemplary and not limiting.

In some examples, the scripting language for CAD may be unit tested. Unit testing may be a software testing method by which individual units of source code are tested to determine whether they are fit for their specified purpose. In addition to capturing whether the code is behaving correctly (e.g., fit for its specified purpose), unit testing may also have the ability to verify through engineering analysis, geometry analysis, etc., that a given designed physical object matches specific requirements and the intent of the design, for example. As used herein, source code may mean sets of one or more computer program modules plus their associated control data, usage procedures, and operating procedures.

In some examples, the scripting language for CAD may be automatically verified.

In some examples, the scripting language for CAD may be automatically deployed.

In some examples, the scripting language for CAD may programmatically design physical or digital designs.

In some examples, the scripting language for CAD may programmatically design physical or digital designs, with or without human intervention.

In some examples, the scripting language for CAD may allow for a continuous spectrum of material properties.

In some examples, the scripting language for CAD may allow object oriented programming of CAD features. As used herein, the term “object oriented programing” may refer to a computer programming model that organizes software design around objects and classes rather than functions and logic.

In some examples, the scripting language for CAD may allow data oriented programming of CAD features. Data oriented programming is a programming language where values of the same type are commonly grouped together in memory. In contrast, object oriented programming focuses more on abstraction away from the data itself, putting items in container-like groupings where access to the memory is more restricted, but easier understandable. For example, data oriented design/programming of a group of students is a list of names with a list of ages; whereas object oriented design is a list of students who each have a name and an age.

In some examples, the scripting language for CAD may allow graphic processor unit (GPU) optimization. As used herein, GPU optimization may mean optimizing code to use the GPU specifically, for most if not all operations called by a user. GU optimization may additionally or alternatively mean using GPU-based multi-threading for most operations and optimizing most, if not all algorithms, to be on the GPU itself.

In some examples, the scripting language for CAD may be multithreaded.

In some examples, the scripting language for CAD may load and edit a CAD file programmatically. By use of the scripting language described herein, changes may be made automatically through scripts and/or API calls created by a user, rather than edits made manually by the user as requested through (e.g., via) a GUI.

In some examples, the scripting language for CAD may treat all CAD features (coordinate systems, sketches, solids, surfaces, edges, etc.) as objects which can be accessed programmatically.

In some examples, the scripting language for CAD may allow programmatic engineering drawing creation.

In some examples, the scripting language for CAD may automatically generate engineering drawings.

Still further, the scripting language circuitry/module 546 may be configured to execute scripting language instructions (software) 556 stored in the computer-readable medium 512 to implement one or more of the exemplary features described above, as well as any other features, functions, aspects, and/or methods described herein that may be related to use of a scripting language as described herein.

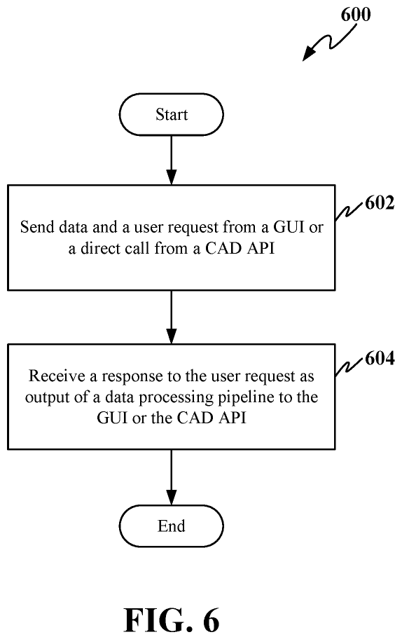

FIG. 6 illustrates an exemplary method 600, operational at a client device, according to aspects described herein. At 602, a processor of the client device (the processor being configured to execute instructions stored in a memory associated with the processor) may send data and a user request from a GUI or from a CAD API (e.g., as a direct call). For example, the transceiver/communication interface 516, the CAD API circuitry/module 544, and/or the processor 504 all of the client device 500 of FIG. 5 may provide a means for sending the data and the user request (from the GUI or from the CAD API) according to some aspects described herein. The memory 510 of the client device 500, as shown and described with reference to FIG. 5, may provide a means for storing instructions, such as the instructions executed by the processor to cause the processor to send the data and the user request at 602. Furthermore, the user interface 518 of the client device 500 of FIG. 5 may provide a means for the user to send the data and user request via the GUI or the CAD API. Still further, the CAD API may be a REST API as described herein.

At 604, the processor of the client device may receive a response to the user request as output of a data processing pipeline. According to some aspects described herein, the data processing pipeline may terminate at the GUI or the CAD API. For example, the transceiver/communication interface 516, the communication and processing circuitry/module 542, the CAD API circuitry/module 544, and/or the processor 504, all of the client device 500 of FIG. 5, may provide a means for receiving the response to the user request as an output of the data processing pipeline according to some aspects described herein.

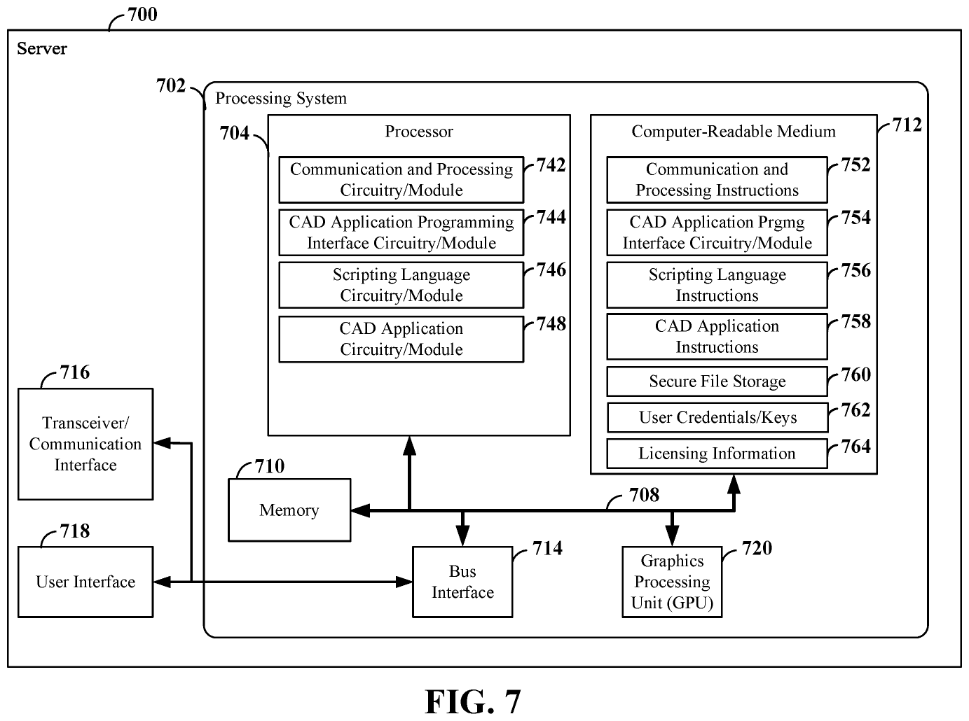

FIG. 7 is a block diagram illustrating an example of a hardware implementation of a server 700 employing a processing system 702 according to some aspects of the disclosure. For example, the server 700 may correspond to the first server 112 through the n^{th} server 116 as shown and described above with reference to FIG. 1 or the server 410 as shown and described with reference to FIG. 4.

The server 700 may be implemented with the processing system 702 that includes one or more processors 704, a bus 708, memory 710, a computer-readable medium 712, a bus interface 714, a graphics processing unit (GPU) 720, a transceiver/communication interface 716, and a user interface 718, all similar to the similarly named components of the client device 500 as shown and described in connection with FIG. 5. The descriptions of similar components are not repeated to avoid duplication.

In some aspects of the disclosure, the processor 704 may include circuitry configured for various functions. For example, the processor 704 may include communication and processing circuitry/module 742, configured to communicate with one or more other servers and/or one or more client devices. Exemplary servers may include the first server 112 through the n^{th} server 116 of FIG. 1, or the server 410 of FIG. 4. Exemplary client devices may include the personal computer 102, the laptop computer 104, the tablet computer 106, the smartphone 108, and/or the terminal 110 of FIG. 1, the client device 402 of FIG. 4, and/or the client device 500 of FIG. 5. Communication may be accomplished via the transceiver/communication interface 716, for example. In one example, the communication and processing circuitry/module 742 may be configured to communicate with a client device via an application programming interface, such as the second endpoint of the CAD API 408B as shown and described with reference to FIG. 4. The features and functions attributed to the communication and processing circuitry/module 742 of FIG. 7 may be the same or similar to the like-named features and functions as described with reference to the communication and processing circuitry/module 542 of FIG. 5 and are not repeated herein to avoid duplication. In some examples, the communication and processing circuitry/module 742 may include one or more hardware components that provide the physical structure that performs processes related to computer aided design. Still further, the communication and processing circuitry/module 742 may be configured to execute communication and processing instructions (software) 752 stored in the computer-readable medium 712 to implement one or more of the exemplary features described above, as well as any other features, functions, aspects, and/or methods described herein that may be related to the use of a CAD application, CAD API, and scripting language as described herein.

In some aspects, the processor 704 may include CAD API circuitry/module 744. The features and functions attributed to the CAD API circuitry/module 744 of FIG. 7 may be the same or similar to like-named features and functions as described with reference to the CAD API circuitry/module 544 of FIG. 5 and are not repeated herein to avoid duplication. In some examples, the CAD API circuitry/module 744 may include one or more hardware components that provide the physical structure that performs processes related to computer aided design. Still further, the CAD API circuitry/module 744 may be configured to execute CAD API instructions (software) 754 stored in the computer-readable medium 712 to implement one or more of the exemplary features described above, as well as any other features, functions, aspects, and/or methods described herein that may be related to the use of a CAD application, CAD API, and scripting language as described herein.

The processor 704 may further include a scripting language circuitry/module 746, configured to provide and utilize a scripting language created to interact with a CAD application, such as one that may be executed by the CAD application circuitry/module 748. Accordingly, the scripting language may be referred to as a scripting language for CAD. According to some aspects, the scripting language may include scripting language for geometric operations in addition to other operations. According to some aspects, the scripting language may or may not include a visual/rendering element. The scripting language circuitry/module 746 may be used to implement one or more exemplary features described with reference to the scripting language circuitry/module 546; accordingly, the descriptions are not repeated to avoid duplication.

Still further, the scripting language circuitry/module 746 may be configured to execute scripting language instructions (software) 756 stored in the computer-readable medium 712 to implement one or more of the exemplary features described above, as well as any other features, functions, aspects, and/or methods described herein that may be related to use of a scripting language as described herein.

The processor 704 may further include a CAD application circuitry/module 748, configured to provide a CAD application that may interface to, for example, the CAD API circuitry/module 744. In some examples, the CAD application circuitry/module 748 may include one or more hardware components that provide the physical structure that performs processes related to computer aided design. Still further, the CAD application circuitry/module 748 may be configured to execute CAD application instructions (software) 758 stored in the computer-readable medium 712 to implement one or more of the exemplary features described above, as well as any other features, functions, aspects, and/or methods described herein that may be related to the use of a CAD application as described herein.

The computer-readable medium 712 may further include secure file storage 760, user credentials/keys 762, and/or licensing information 764, all the same or similar to like-named features described with reference to the computer-readable medium 512 of the client device 500 of FIG. 5. Accordingly, the details of the like-named features are not repeated herein to avoid duplication.

Systems enabled with the CAD application and associated CAD API and scripting languages described herein may form a cloud computing platform that may be used to process, transform, and render geometric data designed in the CAD GUI or through any programming language over a REST API.

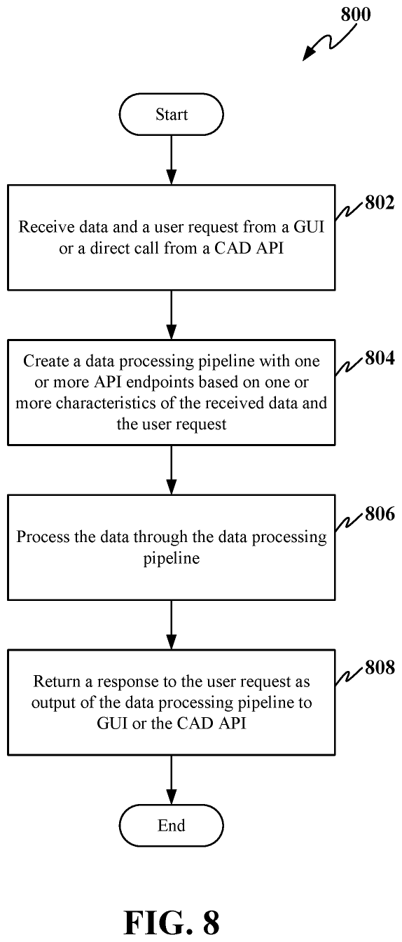

FIG. 8 illustrates an exemplary method 800, operational at a server hosting a CAD application, according to aspects described herein. At 802, a processor of the server (the processor being configured to execute instructions stored in a memory associated with the processor) may receive data and a user request. The data and the user request may be received from a GUI or may comprise a direct call from a CAD API. For example, the transceiver/communication interface 716, the CAD application circuitry/module 748, and/or the processor 704 all of the server 700 of FIG. 7 may provide a means for receiving the data and the user request from the GUI or the direct call from the CAD API according to some aspects described herein. The memory 710 of the server 700, as shown and described with reference to FIG. 7, may provide a means for storing instructions, such as the instructions executed by the processor that may cause the processor to receive the data and the user request at 802. Furthermore, the user interface 518 of the client device 500 of FIG. 5 may provide a means for the user to send the data and user request via the GUI or the CAD API. Still further, the CAD API may be a REST API as described herein.

At 804, the processor may create a data processing pipeline with one or more API endpoints based on the received data's characteristics and the user request. At 806, the processor may process the data through the data processing pipeline. For example, the communication and processing circuitry/module 742 of FIG. 7 may provide a means for creating the data processing pipeline with one or more API endpoints based on one or more characteristics of the received data and the user request and the means for processing the data through the data processing pipeline according to some aspects described herein.

At 808, the processor may return a response to the user request as output of the data processing pipeline to the GUI or the CAD API. For example, the communication and processing circuitry/module 742 and/or the transceiver/communication interface 716 of FIG. 7 may provide a means for sending the output of the data processing pipeline to the GUI or the CAD API according to some aspects described herein.

One or more of the components, processes, features, and/or functions illustrated in FIGS. 1 and 3-8 may be re-arranged and/or combined into a single component, process, feature, or function or embodied in several components, processes, or functions. Additional elements, components, processes, and/or functions may also be added without departing from the disclosure.

The word “exemplary” is used herein to mean “serving as an example, instance, or illustration.” Any implementation or aspect described herein as “exemplary” is not necessarily to be construed as preferred or advantageous over other implementations or aspects described herein.

Likewise, the term “aspects” does not require that all aspects of the disclosure include the discussed feature, advantage, or mode of operation.

The term “coupled” is used herein to refer to the direct or indirect coupling between two objects. For example, if object A physically touches object B, and object B touches object C, then objects A and C may still be considered coupled to one another—even if they do not directly physically touch each other.

The construct “A and/or B” is used herein to mean “A,” “B,” or “A and B.”

Also, it is noted that various disclosures contained herein may be described as a process. Many of the operations of the processes can be performed in parallel or concurrently. In addition, the order of the operations may be re-arranged. A process is terminated when its operations are completed.

While the foregoing disclosure shows illustrative embodiments, it should be noted that various changes and modifications could be made herein without departing from the scope of the disclosure as defined by the appended claims. The functions, steps and/or actions of the method claims in accordance with the embodiments described herein need not be performed in any particular order. Furthermore, although elements of embodiments may be described or claimed in the singular, the plural is contemplated unless limitation to the singular is explicitly stated.

Those of skill in the art would understand that information and signals may be represented using various technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application. Still, such implementation decisions should not be interpreted as causing a departure from the scope of the present invention.

The steps of a method or algorithm, such as those depicted in FIG. 6 and FIG. 8 and described in connection with the embodiments disclosed herein, may be embodied directly in hardware, in a software module executed by a processor, in a software module executed by a GPU, or in any combination of the preceding. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor and/or GPU such that the processor and/or GPU can read information from, and write information to, the storage medium. In the alternative, the storage medium may be integral to the processor and/or the GPU. The processor, the GPU, and the storage medium, or any combination of the processor, the GPU or the storage medium, may reside in an ASIC. The ASIC may reside in a user terminal and/or a server. In the alternative, the processor, the GPU, the storage medium, or any combination thereof may reside as discrete components in a user terminal and/or a server.

In one or more exemplary embodiments, the functions described may be implemented in hardware, software, firmware, or any combination thereof. If implemented in software as a computer program product, the functions may be stored on or transmitted over as one or more instructions or code on a computer-readable medium. Computer-readable media includes both non-transitory computer-readable storage media and communication media including any medium that facilitates transfer of a computer program from one place to another. A storage media may be any available media that a computer can access. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

Although the present disclosure and its advantages have been described in detail, it should be understood that various changes, substitutions, and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include processes, machines, manufacture, compositions of matter, means, methods, or steps within their scope.

1-5. (canceled)

6. A server, comprising:
a processor; and
a memory operationally coupled to the processor, wherein the processor is configured to:
receive data and a user request, via an application programming interface (API) of a computer aided design (CAD) application,
create a data processing pipeline with one or more API endpoints based on characteristics of the data and the user request,
process the data through the data processing pipeline, and
return a response to the user request as output of the data processing pipeline to the API of the CAD application.

7. The server of claim 6, wherein prior to performing a local computation at the server, the processor is further configured to:
send a query to a client device via the API, to determine if a client device processor and a client device memory are sufficient to perform the local computation.

8. The server of claim 6, wherein the data is included in a file configured according to a file type associated with the CAD application, and the file type is different from a file extension.

9. The server of claim 8, wherein the file is accessed programmatically as an object.

10. The server of claim 9, wherein the object:
is at least one of a variable, a data structure, a function, or a method,
is represented in the memory, and
is referenced with an identifier.

11. The server of claim 6, wherein the processor is further configured to:
execute a script obtained via the API and written using a scripting language associated with an application for CAD, and
process at least one file according to the script.

12. The server of claim 11, wherein the script cannot be accessed in an automated manner.

13. The server of claim 6, wherein the CAD application is configured as a common core, below a plurality of sub-applications, the plurality of sub-applications corresponding to respective features of the CAD application.

14. The server of claim 13, wherein the plurality of sub-applications utilize native functions of the common core.

15. The server of claim 13, wherein the common core lies above an operating system kernel.

16. A method, operational at a server, comprising:
receiving data and a user request, via an application programming interface (API) of a computer aided design (CAD) application,
creating a data processing pipeline with one or more API endpoints based on characteristics of the data and the user request,
processing the data through the data processing pipeline, and
returning a response to the user request as output of the data processing pipeline to the API of the CAD application.

17. The method of claim 16, further comprising:
sending a query to a client device via the API, prior to performing a local computation at the server, to determine if a client device processor and a client device memory are sufficient to perform the local computation.

18. The method of claim 16, wherein the data is included in a file configured according to a file type associated with the CAD application, and the file type is different from a file extension.

19. The method of claim 18, wherein the file is accessed programmatically as an object.

20. The method of claim 19, wherein the object:
is at least one of a variable, a data structure, a function, or a method,
is represented in the memory, and
is referenced with an identifier.

21. The method of claim 16, further comprising:
executing a script obtained via the API and written using a scripting language associated with an application for CAD, and
processing at least one file according to the script.

22. The method of claim 21, wherein the script cannot be accessed in an automated manner.

23. The method of claim 16, wherein the CAD application is configured as a common core, below a plurality of sub-applications, the plurality of sub-applications corresponding to respective features of the CAD application.

24. The method of claim 23, wherein the plurality of sub-applications utilize native functions of the common core.

25. The method of claim 23, wherein the common core lies above an operating system kernel.
